(19) United States
(12) Patent Application Publication
(10) Pub. No.: US 2025/0208937 A1
(43) Pub. Date: Jun. 26, 2025

(54) MEMORY FAULT EARLY-WARNING METHOD AND APPARATUS, AND ELECTRONIC DEVICE AND NON-TRANSITORY COMPUTER-READABLE STORAGE MEDIUM

(71) Applicant: SUZHOU METABRAIN INTELLIGENT TECHNOLOGY CO., LTD., Suzhou, Jiangsu (CN)

(72) Inventors: Shuaishuai JIA, Suzhou, Jiangsu (CN); Daotong LI, Suzhou, Jiangsu (CN); Hongrui HAN, Suzhou, Jiangsu (CN); Yandong CHEN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/851,146

(22) PCT Filed: Jun. 29, 2023
(86) PCT No.: PCT/CN2023/104062

§ 371 Date: Sep. 26, 2024

(30) Foreign Application Priority Data
Dec. 21, 2022 (CN) 202211647146.6

(51) Int. Cl. G06F 11/07

(52) U.S. Cl. CPC G06F 11/073; G06F 11/076; G06F 11/0772

(57) ABSTRACT

A memory fault early-warning method and apparatus, and an electronic device and a non-transitory computer-readable storage medium. The method includes: when a Correctable Error (CE) occurs in a memory cell, statistically collecting information of the CE; when the number of times that the CE occurs in the memory cell reaches a reset threshold, determining, as an executable page, a memory page in which the memory cell is located, or when the information of the CE meets an error determination condition of a memory row address, determining, as the executable page, a memory page associated with a memory row in which the memory cell is located; and performing memory fault isolation on the executable page.

### CROSS-REFERENCE TO RELATED APPLICATION

The present application claims priority to Chinese Patent Application No. 202211647146.6 filed to the China National Intellectual Property Administration on Dec. 21, 2022 and entitled “Memory fault early-warning method and apparatus, and electronic device and readable medium”, which is hereby incorporated by reference in its entirety.

### TECHNICAL FIELD

The present disclosure relates to the technical field of computers, and in particular, to a memory fault early-warning method, a memory fault early-warning apparatus, an electronic device, and a computer-readable medium.

### BACKGROUND

Memory errors are errors commonly occurring in computers, and may generally be divided into Correctable Errors (CE) and Uncorrectable Errors (UCE). The CE is an error that may be detected and corrected by a server platform. These errors are generally single bit errors. However, based on processor and memory configurations, these may also be some types of multi-bit errors (which are corrected by advanced Error Correcting Codes (ECC)). The CE may be triggered by a soft fault and a hard fault, which does not disrupt the operation of a server. The UCE is a multi-bit error that cannot be corrected by the server platform. These errors may be triggered by any combination of the soft faults or hard faults, but are generally triggered by a plurality of hard faults. Since the errors are uncorrectable, resulting in data loss, phenomena such as kernel panic, down, etc. generally occur. Therefore, how to suppress the generation of UCEs becomes a problem urgently to be solved.

### SUMMARY

In view of the above problem, embodiments of the present disclosure are proposed to provide a memory fault early-warning method, a corresponding memory fault early-warning apparatus, an electronic device, and a storage medium.

In order to solve the above problem, an embodiment of the present disclosure discloses a memory fault early-warning method, which is applied to a server and includes the following operations.

When a CE occurs in a memory cell, information of the CE is statistically collected.

When the number of times that the CE occurs in the memory cell reaches a reset threshold, a memory page in which the memory cell is located is determined as an executable page, or when the information of the CE meets an error determination condition of a memory row address, a memory page associated with a memory row in which the memory cell is located is determined as the executable page.

Memory fault isolation is performed on the executable page.

In some embodiments of the present disclosure, a method of determining the executable page further includes the following operations.

When the number of times that the CE occurs in the memory cell reaches a preset standard threshold, the memory cell is determined as a first memory cell.

A memory page in which the first memory cell is located is determined as the executable page.

In some embodiments of the present disclosure, the method further includes the following operation.

When the number of times that the CE occurs in the memory cell reaches the preset standard threshold, it is determined that a hard fault occurs in the first memory cell.

In some embodiments of the present disclosure, the memory cells are connected to each other in rows and columns, and a method of determining the reset threshold includes the following operations.

A plurality of memory cells within a preset near range of the first memory cell are determined as second memory cells.

The reset threshold is determined based on distances between the second memory cells and the first memory cell, and the preset standard threshold.

In some embodiments of the present disclosure, the method further includes the following operation.

When there are a plurality of first memory cells around a second memory cell, the reset threshold is determined based on distances between the second memory cell and the plurality of first memory cells, and the preset standard threshold.

In some embodiments of the present disclosure, a processor of the server accesses memory through a cache line, data stored in a plurality of memory particles constitutes the cache line, each of the memory particles includes at least one memory symbol, the memory symbol includes data stored by a plurality of memory cells, each of the memory cells has a memory addresses in a corresponding memory particles, and the plurality of memory cells located at the same memory row have the same memory row address; and the method further includes the following operations.

A memory address corresponding to a memory cell, which stores a first piece of data, in the cache line is determined as a cache line address of the cache line.

When the processor accesses the cache lines with the same cache line address at different moments, the cache lines include at least two memory cells in which the CE occurs, and when a cross-symbol error occurs in the at least two memory cells and the memory row addresses of the at least two memory cells are the same, the memory page is determined as a fault page.

In some embodiments of the present disclosure, determining whether the information of the CE meets the error determination condition of the memory row address includes the following operations.

Whether the memory row addresses of the memory cells, in which the CE occurs, in at least two fault pages are the same is determined.

When the memory row addresses of the memory cells, in which the CE occurs, in at least two fault pages are the same, memory rows in which the memory cells are located are determined as fault rows.

A memory page associated with the fault rows is determined as an executable page.

In some embodiments of the present disclosure, the method further includes the following operation.

When the processor accesses the cache lines with the same cache line address at different moments, and when the at least two memory cells in which the CE occurs are located at different memory symbols, it is determined that the cross-symbol error occurs.

In some embodiments of the present disclosure, the server includes a Baseboard Management Controller (BMC), a Basic Input Output System (BIOS), and an Operating System (OS); a register is disposed in the server; and when the information of the CE is statistically collected by the BMC, the method further includes the following operation.

The BMC collects, in a polling manner, registers in which the CE occurs.

In some embodiments of the present disclosure, the method further includes the following operation.

The register stores memory page address information where the memory cell, in which the CE occurs, is located, system address information, and row information.

In some embodiments of the present disclosure, performing memory fault isolation on the executable page includes the following operations.

When the BMC detects the executable page, an interrupt signal is generated and sent to the OS.

The OS notifies the BIOS to acquire memory page address information of the executable page.

The BIOS records the memory page address information in a platform error record.

An isolation sign is set for the executable page based on the platform error record.

The OS performs memory fault isolation on the executable page by identifying the isolation sign.

In some embodiments of the present disclosure, the server includes a BIOS and an OS; and when the information of the CE is statistically collected by the BIOS, the method further includes the following operation.

A system management interrupt is triggered when the occurrence of a CE is detected.

In some embodiments of the present disclosure, the method further includes the following operation.

The BIOS statistically collects memory page address information where the memory cell, in which the CE occurs, is located, system address information, and row information.

In some embodiments of the present disclosure, performing memory fault isolation on the executable page includes the following operations.

When the BIOS detects the executable page, an interrupt signal is generated and sent to the OS.

The OS notifies the BIOS to acquire memory page address information of the executable page.

The BIOS records the memory page address information in a platform error record.

An isolation sign is set for the executable page based on the platform error record.

The OS performs memory fault isolation on the executable page by identifying the isolation sign.

In some embodiments of the present disclosure, a method of determining the executable page further includes the following operation.

When a sum of the number of times that the CE occurs in the memory cells located in the same memory page reaches a preset error threshold, the same memory page is determined as the executable page; and the preset error threshold is a threshold set for the memory page.

In some embodiments of the present disclosure, a memory fault includes a CE and a UCE.

In some embodiments of the present disclosure, the method further includes the following operation.

The server detects whether the CE occurs.

An embodiment of the present disclosure further discloses a memory fault early-warning apparatus, which is applied to a server and includes a statistics module, a determination module, and an isolation module.

The statistics module is configured to, when a CE occurs in a memory cell, statistically collect information of the CE.

The determination module is configured to, when the number of times that the CE occurs in the memory cell reaches a reset threshold, determine, as an executable page, a memory page in which the memory cell is located, or when the information of the CE meets an error determination condition of a memory row address, determine, as the executable page, a memory page associated with a memory row in which the memory cell is located.

The isolation module is configured to perform memory fault isolation on the executable page.

An embodiment of the present disclosure further discloses an electronic device, including a processor, a communication interface, a memory and a communication bus. The processor, the communication interface and the memory communicate with each other by means of the communication bus.

The memory is configured to store a computer program.

The processor is configured to implement the method of the embodiments of the present disclosure when executing the program stored in the memory.

An embodiment of the present disclosure further discloses at least one non-transitory computer-readable storage medium, wherein the non-transitory computer-readable storage medium is configured to store an instruction. When the instruction is executed by at least one processor, the at least one processor performs the method of the embodiments of the present disclosure.

The embodiments of the present disclosure include the following advantages: by means of, when the CE occurs in the memory cell, statistically collecting the information of the CE, when the number of times that the CE occurs in the memory cell reaches the reset threshold, determining, as the executable page, the memory page in which the memory cell is located, or when the information of the CE meets the error determination condition of the memory row address, determining, as the executable page, the memory page associated with the memory row in which the memory cell is located, and performing memory fault isolation on the executable page, threshold resetting of a near space of the memory cell, in which the number of times that a memory fault occurs exceeds a threshold, is realized; an error determination mechanism of the memory row address and a fault determination mechanism regarding a memory page are introduced, such that the occurrence probability of a UCE may be effectively reduced, and the occurrence of the UCE is thus suppressed, thereby avoiding situations such as a server having a kernel panic and the server going down; and meanwhile, by statistically collecting the information of the executable page, causes of errors may be further analyzed.

### BRIEF DESCRIPTION OF THE DRAWINGS

FIG. 1 is a diagram of a composition structure of a Dynamic Random Access Memory (DRAM).

FIG. 1a is a partial enlarged view of FIG. 1.

FIG. 2 is a schematic storage diagram of a DRAM.

FIG. 2a is a partial enlarged view of FIG. 2.

FIG. 3a is a schematic diagram of a CE.

FIG. 3b is a schematic diagram of a UCE.

FIG. 4 is a flowchart of steps of a memory fault early-warning method according to embodiments of the present disclosure.

FIG. 5 is a flowchart of steps of another memory fault early-warning method according to embodiments of the present disclosure.

FIG. 6a is a schematic diagram of a near space of a first memory cell in a memory fault early-warning method according to embodiments of the present disclosure.

FIG. 6b is a schematic diagram of near spaces of a plurality of first memory cells in a memory fault early-warning method according to embodiments of the present disclosure.

FIG. 7a is a schematic diagram of a fault page in a memory fault early-warning method according to embodiments of the present disclosure.

FIG. 7b is a schematic diagram of a fault row in a memory fault early-warning method according to embodiments of the present disclosure.

FIG. 8 is a flowchart of a memory fault early-warning method according to embodiments of the present disclosure.

FIG. 9 is a flowchart of steps of another memory fault early-warning method according to embodiments of the present disclosure.

FIG. 10 is a flowchart of another memory fault early-warning method according to embodiments of the present disclosure.

FIG. 11 is a block structural diagram of a memory fault early-warning apparatus according to embodiments of the present disclosure.

FIG. 12 is a block diagram of an electronic device according to embodiments of the present disclosure.

FIG. 13 is a schematic diagram of a non-transitory computer-readable storage medium according to embodiments of the present disclosure.

### DETAILED DESCRIPTION OF THE EMBODIMENTS

In order to make the above objectives, features and advantages of the present disclosure more obvious and easier to understand, the present disclosure is further described below in detail with the drawings and some embodiments.

For ease of a better understanding of the present disclosure by those skilled in the art, relevant technologies involved in the present disclosure are introduced below.

Soft faults are transient in nature and may often be triggered by electrical disturbances in memory subsystem components. These electrical disturbances may occur at any one of many positions in a memory subsystem, including a processor memory controller, an internal processor bus, a processor cache, a processor socket or connector, a mainboard bus route, a discrete memory buffer chip (if present), a Dual-Inline-Memory-Module (DIMM) connector, or a single DRAM assembly on a DIMM.

The soft faults may be triggered by phenomena such as high-energy electron collisions in the memory subsystem or electrical noise in a circuit. A single bit or multiple bits may all be affected, and a single bit error and some multi-bit errors are corrected by using requirements or patrol scrubbing.

Hard faults are persistent in nature and cannot be resolved over time or through a system reset or reboot. This type of faults may be: a. inherent faults (i.e., the aging of a single channel on a bus or a single memory cell in a DRAM assembly); b. a fault of the entire device (e.g., a connector, a processor, a memory buffer, or the DRAM assembly); and c. incorrect bus initialization or a fault caused by memory power problems. The fault in the DRAM assembly may include a fault in the entire device, a fault in a bank region in the device, a pin fault, and a fault in a column or memory cell.

The hard faults may be caused by damage to physical components, electrostatic discharge, electrical overcurrent conditions, excessive temperature conditions, and irregularities in processor or DRAM manufacturing or module assembly.

The soft faults and the hard faults eventually lead to two types of memory errors: CEs and UCEs.

The CE is an error that may be detected and corrected by a server platform. These errors are generally single bit errors. However, based on processor and memory configurations, these may also be some types of multi-bit errors (which are corrected by an advanced ECC). The CE may be triggered by a soft fault and a hard fault, which does not disrupt the operation of a server.

As a DRAM-based memory geometrically shrinks to increase capacity, as a natural portion of uniform scaling, more and more CEs are expected. In addition, due to various other DRAM scaling factors (e.g., reducing the capacitance of a memory cell), an increase in the number of error-generating phenomena is expected, for example, Variable Retention Time (VRT) and Random Telegraph Noise (RTN).

The UCE is a multi-bit error that cannot be corrected by the server platform. These errors may be triggered by any combination of the soft faults or hard faults, but are generally triggered by a plurality of hard faults. Not all multi-bit errors are uncorrectable. A processor supporting the advanced ECC may correct some types of multi-bit errors, provided that it depends on a bit error pattern.

A memory UCE is a very serious error, and since the error is uncorrectable, resulting in data loss, phenomena such as kernel panic, down, etc. generally occur.

Suppression of the memory UCE:

From memory error classification, it may be concluded that the memory UCE is usually triggered by the plurality of hard faults. Then, evolution and classification of hard faults of a memory are introduced below.

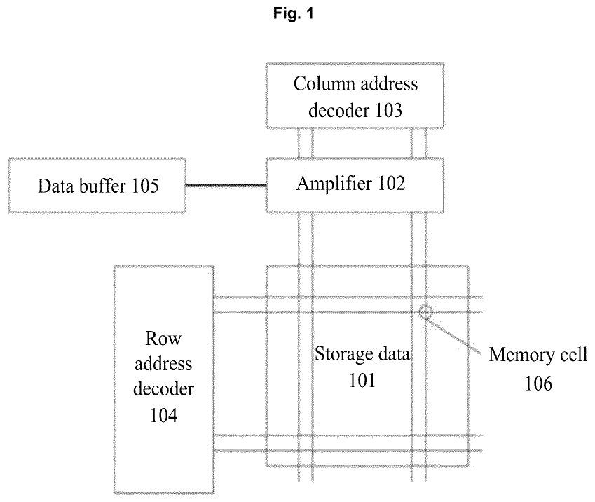

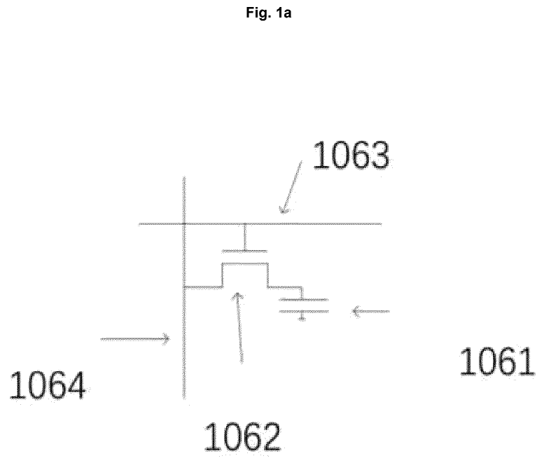

FIG. 1 is a diagram of a composition structure of a DRAM, including storage data 101 (Memory Array), an amplifier 102 (Sense Amps), a column address decoder 103, a row address decoder 104, and a data buffer 105 (Data In/Out Buffer); and it may be seen that a basic storage cell thereof is a memory cell 106. Referring to FIG. 1a, a partial enlarged view of FIG. 1, showing a structural diagram of the memory cell 106, each memory cell 106 consists of a storage capacitor 1061, a transistor 1062, a row address 1063 (Word Line), and a column address 1064 (Bit Line).

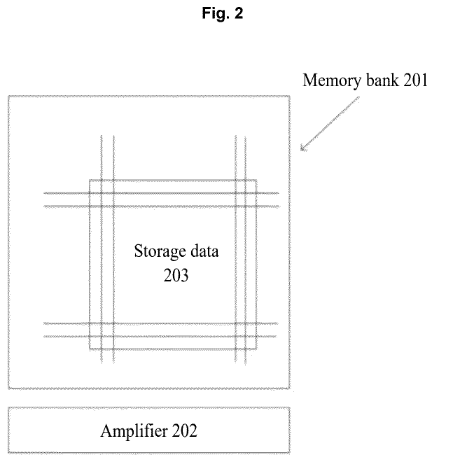

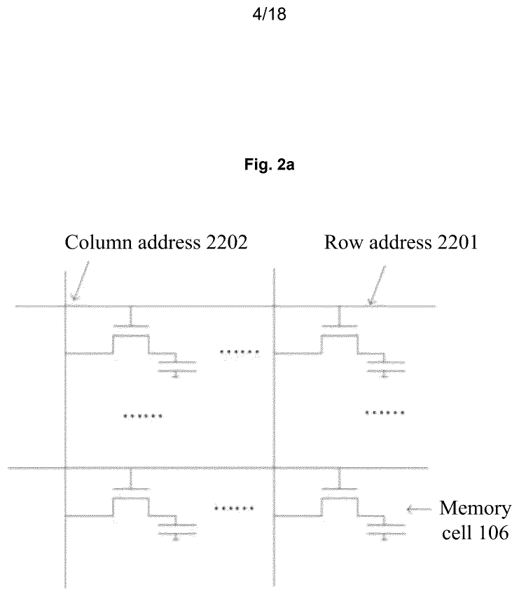

FIG. 2 is a schematic storage diagram of a DRAM, including a memory bank 201 and an amplifier 202. The memory bank 201 includes storage data 203. The memory cells saving the storage data 203 are arranged in rows and columns. FIG. 2a is a partial enlarged view of FIG. 2.

When a row address 2201 is valid, the entire row is selected. When a column address 2202 is valid, a particular column is then selected, and 1-bit data stored in the memory cell 106 is saved in the data buffer. The row address 2201 and the column address 2202 form one piece of storage data.

When data is read, the row address 2201 is set to be at a logic high level, the transistor 1062 is turned on, and then a state on the column address 2202 is read.

When the data is written, a level state to be written is first set to the column address 2202, then the transistor 1062 is turned on, and a state in the storage capacitor 1061 is changed by the column address 2202. Through investigation and research, a cell that is most prone to failure in a memory data reading process is the storage capacitor 1061.

When the memory cell 106 of the memory fails, a near memory cell 106 of a physical space thereof may be jeopardized, or it indicates that the memory cell 106 of a near space thereof is also already at risk of deterioration, and may cause more single bit errors.

When the transistor 1062 of one memory cell 106 is damaged and the storage capacitor 1061 is damaged, the row address 2201 fails, and all memory cells connected to the row address 2201 are jeopardized.

When a memory structure and a read process are learned, it can be deduced that the maximum percentage of memory faults is the single bit error, followed by row errors in second place.

When a memory controller reads cache line data once, when a single bit error appears, the single bit error may be corrected, belonging to a memory CE. When the cache line data read by the memory controller once includes a plurality of bit errors, when a CPU supports the advanced ECC, the situation is as follows.

The advanced ECC is a highly complex feature, and is based on a Single Symbol Correcting-Double Symbol Detecting (SSC-DSD) Reed-Solomon correction and detection code.

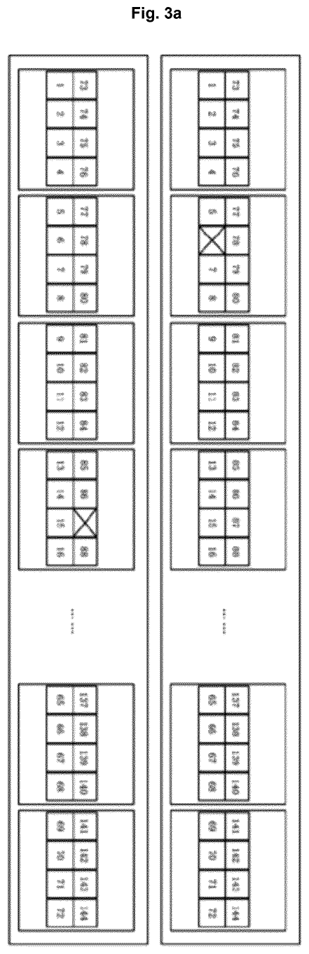

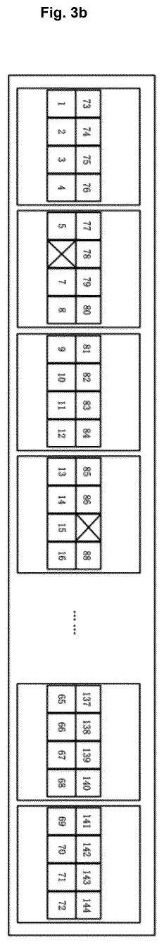

By using this correction mechanism, when a single memory cell error occurs in all cache lines having the same cache line address at two different moments, the single memory cell error may be corrected, as shown in FIG. 3a, “x” represents data in which an error occurs. When two occurrences of the single memory cell error are happened in the cache line at the same time, since the two memory cell errors across symbols, the memory cell errors are uncorrectable, as shown in FIG. 3b, “x” represents the data in which an error occurs, and since faults in the two memory cells across symbols, the faults are uncorrectable.

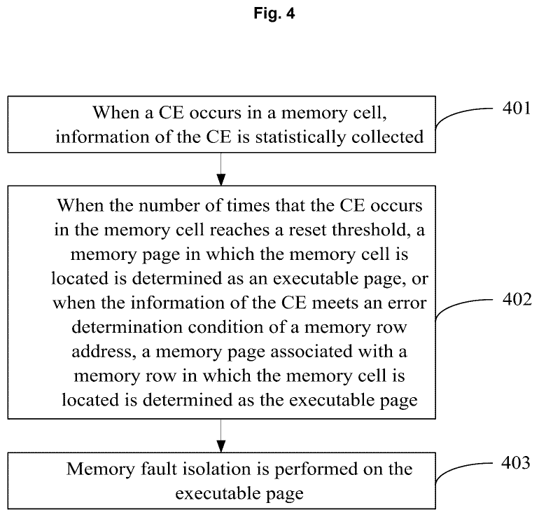

FIG. 4 is a flowchart of steps of a memory fault early-warning method according to embodiments of the present disclosure. The method is applied to a server and may include the following steps.

At step 401, when a CE occurs in a memory cell, information of the CE is statistically collected.

When a CE occurs in a memory cell of the server, the server may statistically collect related information of the CE.

In some embodiments of the present disclosure, a memory fault includes a CE and a UCE.

A memory error in the server includes the CE and the UCE. The CE is an error that may be detected and corrected by a server platform. The CE may be triggered by a soft fault and a hard fault, which does not disrupt the operation of the server. The UCE is a multi-bit error that cannot be corrected by the server platform.

In some embodiments of the present disclosure, the method further includes the following operation.

The server detects whether the CE occurs.

When a memory fault in the server, a type of the memory fault may be automatically detected, and when the type of the memory fault is the CE, the information related to the CE is statistically collected.

At step 402, when the number of times that the CE occurs in the memory cell reaches a reset threshold, a memory page in which the memory cell is located is determined as an executable page, or when the information of the CE meets an error determination condition of a memory row address, a memory page associated with a memory row in which the memory cell is located is determined as the executable page.

A page is a unit of access to memory data. The size of one memory page is 4K, that is, the size of data that may be accessed at one time is 4K. When a hard fault occurs in a memory cell in the memory page, a memory cell of a near space is affected, and the probability of a fault in the memory cell of the near space increases. In order to prevent the server from accessing the memory page in which the memory cell, in which the hard fault occurs, is located, a reset threshold may be set for the memory cell of the near space, and when the number of times that an error occurs in the memory cell of the near space reaches the reset threshold, the memory page in which the memory cell of the near space is located is determined as an executable page. When the hard fault occurs in the memory cell in the memory page, the memory cells having the same memory row address may be affected, and when a memory fault occurring meets the error determination condition of the memory row address, the memory pages in which all memory cells associated with the memory row are located are set as the executable pages.

In order to accelerate memory accesses in parallel, continuous regions of a memory address are generally staggered on a DIMM. On an existing server, an average memory row may include data from up to 48 4K-byte pages.

In some embodiments of the present disclosure, a method of determining the executable page further includes the following operation.

When a sum of the number of times that the CE occurs in the memory cells located in the same memory page reaches a preset error threshold, the same memory page is determined as the executable page; and the preset error threshold is a threshold set for the memory page.

In some embodiments of the present disclosure, an error threshold may be set for the memory page, and when the sum of the number of times that the CE occurs in the memory cells located in the same memory page reaches the error threshold, the same memory page is determined as the executable page.

At step 403, memory fault isolation is performed on the executable page.

Since the executable page includes the memory cell in which a fault may occur, after the executable page is determined, a memory fault isolation operation may be performed on the executable page, so as to guarantee the health of a memory space used by application layer software. Memory fault isolation is a technology for isolating a memory page at an OS level. After being isolated, the memory page can be no longer used by the application layer software.

In the embodiments of the present disclosure, by means of, when the CE occurs in the memory cell, statistically collecting the information of the CE, when the number of times that the CE occurs in the memory cell reaches the reset threshold, determining, as the executable page, the memory page in which the memory cell is located, or when the information of the CE meets the error determination condition of the memory row address, determining, as the executable page, the memory page associated with the memory row in which the memory cell is located, and performing memory fault isolation on the executable page, threshold resetting of a near space of the memory cell, in which the number of times that a memory fault occurs exceeds a threshold, is realized; an error determination mechanism of the memory row address and a fault determination mechanism regarding a memory page are introduced, such that the occurrence probability of a UCE may be effectively reduced, and the occurrence of the UCE is thus suppressed, thereby avoiding situations such as a server having a kernel panic and the server going down; and meanwhile, by statistically collecting the information of the executable page, causes of errors may be further analyzed.

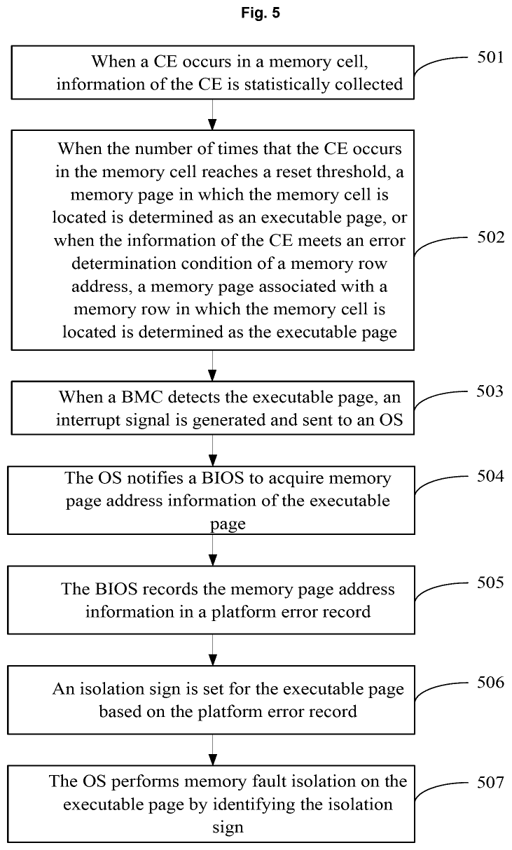

FIG. 5 is a flowchart of steps of another memory fault early-warning method according to embodiments of the present disclosure. The method is applied to a server and may include the following steps.

At step 501, when a CE occurs in a memory cell, information of the CE is statistically collected.

When a CE occurs in a memory cell of the server, the server may statistically collect related information of the CE.

In some embodiments of the present disclosure, the server includes a BMC, a BIOS, and an OS; a register is disposed in the server; and when the information of the CE is statistically collected by the BMC, the method further includes the following operation.

The BMC collects, in a polling manner, registers in which the CE occurs.

In some embodiments of the present disclosure, the server includes the BMC, the BIOS, and the OS. The BMC may perform some operations such as performing firmware upgrade on a machine, checking machine devices, etc. when the server is not turned on. The BIOS saves the most important basic input output program of a computer, a self-test program after startup, and a system self-startup program, and a main function of the BIOS is to provide the lowest level and most direct hardware setup and control for the computer. The OS is a set of interrelated system software programs that supervise and control the computer to operate, use, and run hardware or software resources and provide public services to organize user interactions.

The register is disposed in the server; and when the information of the CE is statistically collected by the BMC, the BMC collects, in a polling manner, registers in which the CE occurs.

In some embodiments of the present disclosure, the method further includes the following operation.

The register stores memory page address information where the memory cell, in which the CE occurs, is located, system address information, and row information.

When the CE occurs in the register, the register may store the related information of the CE, for example, the memory page address information where the memory cell, in which the CE occurs, is located, the system address information, and the row information. The memory page address information may reflect a memory page address in which the memory cell, in which the CE occurs, is located; and the system address information may reflect a system address in which the memory cell, in which the CE occurs, is located, for example, a processor memory controller, an internal processor bus, a processor cache, a processor socket or connector, a mainboard bus route, a discrete memory buffer chip (if present), a DIMM connector, a single DRAM assembly on a DIMM, etc. The row information may reflect memory row address information of the memory cell in which the CE occurs.

At step 502, when the number of times that the CE occurs in the memory cell reaches a reset threshold, a memory page in which the memory cell is located is determined as an executable page, or when the information of the CE meets an error determination condition of a memory row address, a memory page associated with a memory row in which the memory cell is located is determined as the executable page.

When a hard fault occurs in a memory cell in the memory page, a memory cell of a near space is affected, and the probability of a fault in the memory cell of the near space increases. In order to prevent the server from accessing the memory page in which the memory cell, in which the hard fault occurs, is located, a reset threshold may be set for the memory cell of the near space, and when the number of times that an error occurs in the memory cell of the near space reaches the reset threshold, the memory page in which the memory cell of the near space is located is determined as an executable page. When the hard fault occurs in the memory cell in the memory page, the memory cells having the same memory row address may be affected, and when a memory fault occurring meets the error determination condition of the memory row address, the memory pages in which all memory cells associated with the memory row are located are set as the executable pages.

In some embodiments of the present disclosure, a method of determining the executable page further includes the following operation.

When the number of times that the CE occurs in the memory cell reaches a preset standard threshold, the memory cell is determined as a first memory cell.

In some embodiments of the present disclosure, when the number of times that the CE occurs in the memory cell reaches the preset standard threshold, the memory cell is determined as the first memory cell, and the preset standard threshold may be obtained by those skilled in the art through a lot of experiments, or set according to the experience of those skilled in the art.

A memory page in which the first memory cell is located is determined as the executable page.

After the first memory cell is determined, the memory page in which the first memory cell is located may be determined as the executable page.

In some embodiments of the present disclosure, the method further includes the following operation.

When the number of times that the CE occurs in the memory cell reaches the preset standard threshold, it is determined that a hard fault occurs in the first memory cell.

When the number of times that the CE occurs in the memory cell reaches the preset standard threshold, it indicates that the current memory fault is uncorrectable, and it may be determined that the hard fault occurs in the first memory cell.

In some embodiments of the present disclosure, the memory cells are connected to each other in rows and columns, and a method of determining the reset threshold includes the following operations.

A plurality of memory cells within a preset near range of the first memory cell are determined as second memory cells.

When the first memory cell appears, since the memory cell in which the hard fault occurs affects the memory cells within a near range, and the probability of a fault in the memory cell of the near space increases, other memory cells in the near space of the first memory cell may be determined as the second memory cells, and a fault threshold is reset for the second memory cells.

The reset threshold is determined based on distances between the second memory cells and the first memory cell, and the preset standard threshold.

It is understandable that, when the second memory cell is closer to the first memory cell, the second memory cell is more affected by the first memory cell, such that different reset thresholds may be set for the second memory cells with different distances.

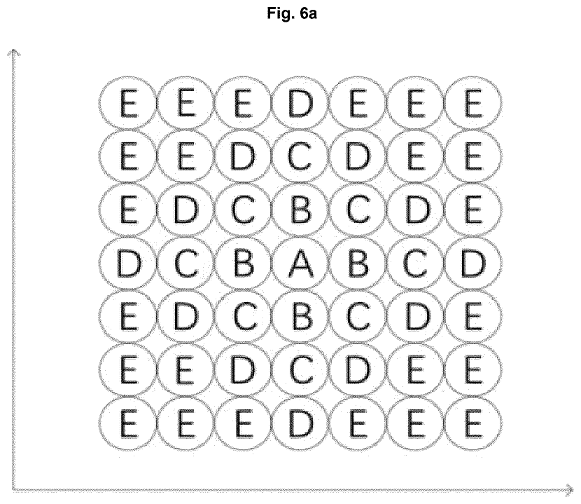

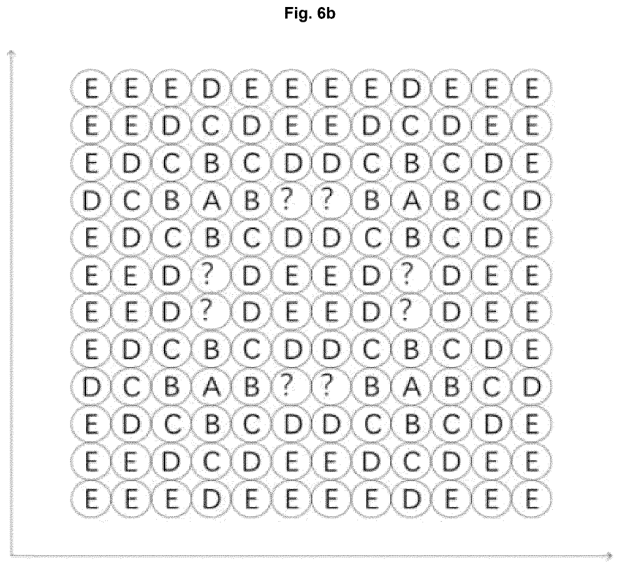

FIG. 6a is a schematic diagram of the near space of the first memory cell. As shown in FIG. 6a, “A” is the first memory cell, “B”, “C”, “D”, and “E” are all second memory cells, and different threshold levels may be set. Since “A” is the first memory cell, and a fault in the first memory cell has been determined, a corresponding threshold level thereof may be set to 0; “B” is the second memory cell at a distance of 1 from “A”, and a threshold level thereof may be set to 25%; “C” is the second memory cell at a distance of 2 from “A”, and a threshold level thereof may be set to 50%; and so on, a threshold level of “D” may be set to 75%; and a threshold level of “E” may be set to 100%. Then, the reset threshold of the second memory cell may be obtained by multiplying the threshold level corresponding to the second memory cell by the standard threshold. When the standard threshold is set to 100, a reset threshold corresponding to “B” is 25, a reset threshold corresponding to “C” is 50, a reset threshold corresponding to “D” is 75, and a reset threshold corresponding to “E” is 100.

In some embodiments of the present disclosure, the method further includes the following operation.

When there are a plurality of first memory cells around a second memory cell, the reset threshold is determined based on distances between the second memory cell and the plurality of first memory cells, and the preset standard threshold.

It is understandable that, the second memory cell may also be located at a position where near ranges of the plurality of first memory cells overlap, and in this case, the reset threshold of the second memory cell is determined based on distances between the second memory cell and the plurality of first memory cells, and the preset standard threshold. As shown in FIG. 6b, “?” is a position where the near ranges of two memory cells overlap, a threshold level corresponding to one of the memory cells is 50%, and a threshold level corresponding to the other memory cell is 75%; and when the standard threshold is set to 200, a reset threshold of “?” is 75.

In some embodiments of the present disclosure, a processor of the server accesses memory through a cache line, data stored in a plurality of memory particles constitutes the cache line, each of the memory particles includes at least one memory symbol, the memory symbol includes data stored by a plurality of memory cells, each of the memory cells has a memory addresses in a corresponding memory particles, and the plurality of memory cells located at the same memory row have the same memory row address; and the method further includes the following operations.

A memory address corresponding to a memory cell, which stores a first piece of data, in the cache line is determined as a cache line address of the cache line.

The cache line is the smallest unit of memory accessed by the processor of the server. The cache line is read by a memory controller of the processor. In one example, one cache line may include 512-bit data, and one memory cell represents one-bit data. It is understandable that, the sizes of the memory particles are related to the model of the DIMM. When the DIMM is ×4, one memory particle includes one memory symbol; and when the DIMM is ×8, one memory particle includes 2 memory symbols. Each memory symbol includes data stored by the plurality of memory cells; the memory address is an address in which the memory cell is stored in the memory particle; and the memory cells located at the same memory row have the same memory row address.

Data in the memory of the server changes continuously, and a memory address corresponding to the memory cell, which stores the first piece of data, in the cache line may be determined as the cache line address of the cache line.

When the processor accesses the cache lines with the same cache line address at different moments, the cache lines include at least two memory cells in which the CE occurs, and when a cross-symbol error occurs in the at least two memory cells and the memory row addresses of the at least two memory cells are the same, the memory page is determined as a fault page.

When the server accesses the cache lines with the same cache line address at different moments, the cache lines includes at least two memory cells in which the CE occurs, and when a cross-symbol error occurs in the at least two memory cells and the memory row addresses of the at least two memory cells are the same, the memory page is determined as the fault page.

In some embodiments of the present disclosure, the method further includes the following operation.

When the processor accesses the cache lines with the same cache line address at different moments, and when the at least two memory cells in which the CE occurs are located at different memory symbols, it is determined that the cross-symbol error occurs.

When the processor accesses the cache lines with the same cache line address at different moments, and when the at least two memory cells in which the CE occurs are respectively located at different memory symbols, it may be determined that the cross-symbol error occurs.

In some embodiments of the present disclosure, determining whether the information of the CE meets the error determination condition of the memory row address includes the following operations.

Whether the memory row addresses of the memory cells, in which the CE occurs, in at least two fault pages are the same is determined.

When the memory row addresses of the memory cells, in which the CE occurs, in at least two fault pages are the same, memory rows in which the memory cells are located are determined as fault rows.

A memory page associated with the fault rows is determined as an executable page.

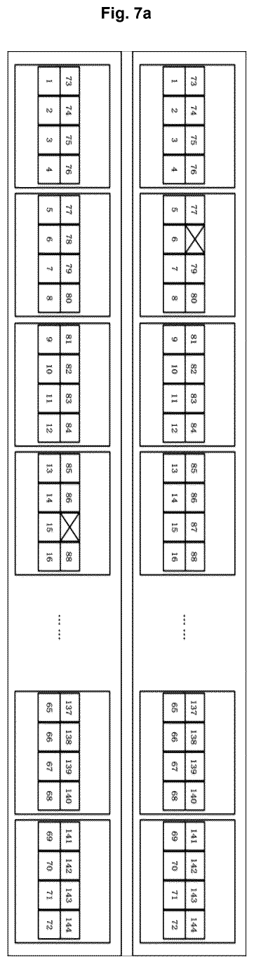

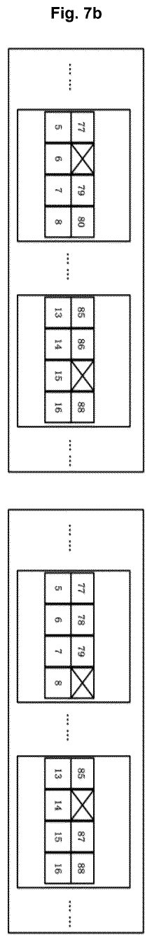

When whether the error determination condition of the memory row address is met is determined, when it is determined that there are at least two fault pages, and memory row addresses of the memory cells, in which the CE occurs, in the two fault pages are the same, the memory rows at which the memory cells are located are determined as the fault rows, and all the memory pages associated with the fault rows are determined as the executable pages. As shown in FIG. 7a, “x” represents data in which an error occurs, there are two memory cells in the cache line in which the CE occurs at different moments, the two memory cells are located in different memory symbols, a cross-symbol error occurs, and the memory row addresses are the same, such that the memory page in which the cache line is located is determined as the fault page. As shown in FIG. 7b, “x” represents the data in which an error occurs, the memory cells, in which the CE occurs, in two fault pages are located at the same memory row, and the memory row addresses are the same, such that the memory row is determined as the fault row, and the memory page associated with the fault row is determined as the executable page.

At step 503, when the BMC detects the executable page, an interrupt signal is generated and sent to the OS.

When the BMC detects the executable page, one interrupt signal is generated and sent to the OS for software interrupt.

At step 504, the OS notifies the BIOS to acquire memory page address information of the executable page.

After receiving the interrupt signal, the OS notifies the BIOS to acquire memory page address information of the executable page stored in the BMC.

At step 505, the BIOS records the memory page address information in a platform error record.

After the BIOS acquires the memory page address information stored in the BMC, the BIOS records the memory page address information in the platform error record.

At step 506, an isolation sign is set for the executable page based on the platform error record.

After the BIOS records the memory page address information in the platform error record, the isolation sign may be set for the executable page.

At step 507, the OS performs memory fault isolation on the executable page by identifying the isolation sign.

When the OS accesses memory data, the OS performs memory fault isolation on the executable page by identifying the isolation sign, thereby avoiding the calling of the memory cell in which a fault may exist.

In the embodiments of the present disclosure, by means of, when the CE occurs in the memory cell, statistically collecting the information of the CE, when the number of times that the CE occurs in the memory cell reaches the reset threshold, determining, as the executable page, the memory page in which the memory cell is located, or when the information of the CE meets the error determination condition of the memory row address, determining, as the executable page, the memory page associated with the memory row in which the memory cell is located, and performing memory fault isolation on the executable page, threshold resetting of a near space of the memory cell, in which the number of times that a memory fault occurs exceeds a threshold, is realized; an error determination mechanism of the memory row address and a fault determination mechanism regarding a memory page are introduced, such that the occurrence probability of a UCE may be effectively reduced, and the occurrence of the UCE is thus suppressed, thereby avoiding situations such as a server having a kernel panic and the server going down; and meanwhile, by statistically collecting the information of the executable page, causes of errors may be further analyzed.

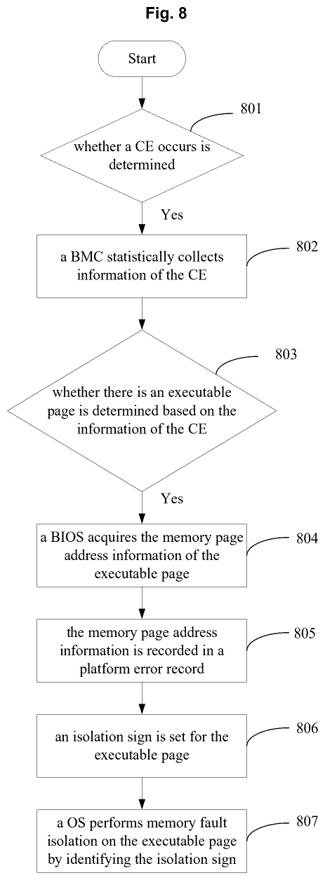

FIG. 8 is a flowchart of a memory fault early-warning method according to embodiments of the present disclosure. The method may include the following steps.

At step 801, whether a CE occurs is determined, and when the CE occurs, step 802 is executed.

At step 802, the BMC statistically collects information of the CE.

At step 803, whether there is an executable page is determined based on the information of the CE, where a determination method may include: determining whether the number of times that the CE occurs in the memory cell reaches a preset standard threshold; determining whether the number of times that the CE occurs in the memory cell reaches a reset threshold; determining whether the information of the CE meets an error determination condition of a memory row address; and determining that the sum of the number of times that the CE occurs in the memory cells in the same memory page reaches a preset error threshold, and when any one of the conditions is met, executing step 804.

At step 804, the BIOS acquires the memory page address information of the executable page.

At step 805, the memory page address information is recorded in a platform error record.

At step 806, an isolation sign is set for the executable page.

At step 807, the OS performs memory fault isolation on the executable page by identifying the isolation sign.

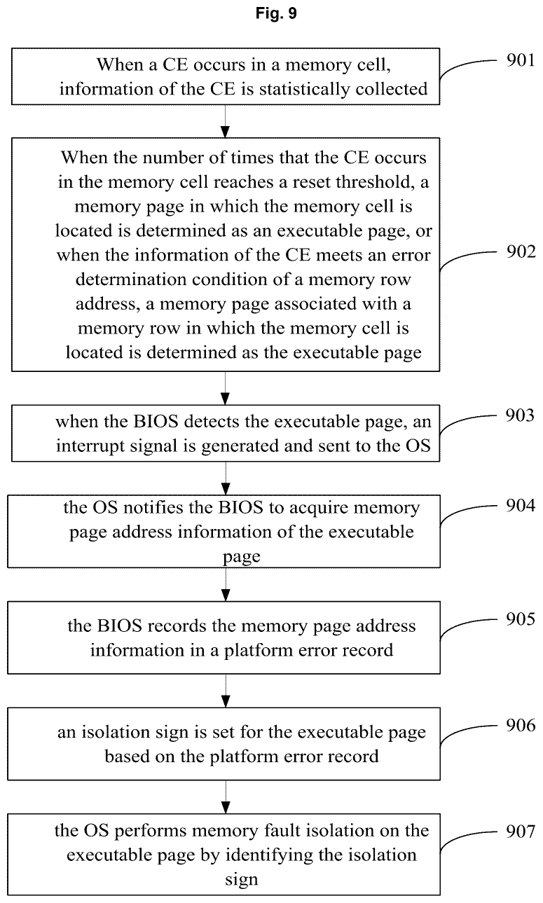

FIG. 9 is a flowchart of steps of another memory fault early-warning method according to embodiments of the present disclosure. The method is applied to a server and may include the following steps.

At step 901, when a CE occurs in the memory cell, information of the CE is statistically collected.

When a CE occurs in a memory cell of the server, the server may statistically collect related information of the CE.

In some embodiments of the present disclosure, the server includes a BIOS and an OS; and when the information of the CE is statistically collected by the BIOS, the method further includes the following operation.

A system management interrupt is triggered when the occurrence of a CE is detected.

When the information of the CE is statistically collected by the BIOS, when a memory fault occurs, the server detects a type of the fault and triggers the system management interrupt.

In some embodiments of the present disclosure, the method further includes the following operation.

The BIOS statistically collects memory page address information where the memory cell, in which the CE occurs, is located, system address information, and row information.

After the system management interrupt is triggered, the BIOS may statistically collect the memory page address information where the memory cell, in which the CE occurs, is located, the system address information, and the row information.

At step 902, when the number of times that the CE occurs in the memory cell reaches a reset threshold, a memory page in which the memory cell is located is determined as an executable page, or when the information of the CE meets an error determination condition of a memory row address, a memory page associated with a memory row in which the memory cell is located is determined as the executable page.

When a hard fault occurs in a memory cell in the memory page, a memory cell of a near space is affected, and the probability of a fault in the memory cell of the near space increases. In order to prevent the server from accessing the memory page in which the memory cell, in which the hard fault occurs, is located, a reset threshold may be set for the memory cell of the near space, and when the number of times that an error occurs in the memory cell of the near space reaches the reset threshold, the memory page in which the memory cell of the near space is located is determined as an executable page. When the hard fault occurs in the memory cell in the memory page, the memory cells having the same memory row address may be affected, and when a memory fault occurring meets the error determination condition of the memory row address, the memory pages in which all memory cells associated with the memory row are located are set as the executable pages.

In some embodiments of the present disclosure, the method of determining the executable page further includes the following operation.

When the number of times that the CE occurs in the memory cell reaches a preset standard threshold, the memory cell is determined as a first memory cell.

In some embodiments of the present disclosure, when the number of times that the CE occurs in the memory cell reaches the preset standard threshold, the memory cell is determined as the first memory cell, and the preset standard threshold may be obtained by those skilled in the art through a lot of experiments, or set according to the experience of those skilled in the art.

The memory page in which the first memory cell is located is determined as the executable page.

After the first memory cell is determined, the memory page in which the first memory cell is located may be determined as the executable page.

In some embodiments of the present disclosure, the method further includes the following operation.

When the number of times that the CE occurs in the memory cell reaches the preset standard threshold, it is determined that a hard fault occurs in the first memory cell.

When the number of times that the CE occurs in the memory cell reaches the preset standard threshold, it indicates that the current memory fault is uncorrectable, and it may be determined that the hard fault occurs in the first memory cell.

In some embodiments of the present disclosure, the memory cells are connected to each other in rows and columns, and the method of determining the reset threshold includes the following operations.

A plurality of memory cells within a preset near range of the first memory cell are determined as second memory cells.

When the first memory cell appears, since the memory cell in which the hard fault occurs affects the memory cells within a near range, and the probability of a fault in the memory cell of the near space increases, other memory cells in the near space of the first memory cell may be determined as the second memory cells, and a fault threshold is reset for the second memory cells.

The reset threshold is determined based on distances between the second memory cells and the first memory cell, and the preset standard threshold.

It is understandable that, when the second memory cell is closer to the first memory cell, the second memory cell is more affected by the first memory cell, such that different reset thresholds may be set for the second memory cells with different distances.

FIG. 6a is a schematic diagram of the near space of the first memory cell. As shown in FIG. 6a, “A” is the first memory cell, “B”, “C”, “D”, and “E” are all second memory cells, and different threshold levels may be set. Since “A” is the first memory cell, and a fault in the first memory cell has been determined, a corresponding threshold level thereof may be set to 0; “B” is the second memory cell at a distance of 1 from “A”, and a threshold level thereof may be set to 25%; “C” is the second memory cell at a distance of 2 from “A”, and a threshold level thereof may be set to 50%; and so on, a threshold level of “D” may be set to 75%; and a threshold level of “E” may be set to 100%. Then, the reset threshold of the second memory cell may be obtained by multiplying the threshold level corresponding to the second memory cell by the standard threshold. When the standard threshold is set to 100, a reset threshold corresponding to “B” is 25, a reset threshold corresponding to “C” is 50, a reset threshold corresponding to “D” is 75, and a reset threshold corresponding to “E” is 100.

In some embodiments of the present disclosure, the method further includes the following operation.

When there are a plurality of first memory cells around the second memory cell, the reset threshold is determined based on distances between the second memory cell and the plurality of first memory cells, and the preset standard threshold.

It is understandable that, the second memory cell may also be located at a position where near ranges of the plurality of first memory cells overlap, and in this case, the reset threshold of the second memory cell is determined based on distances between the second memory cell and the plurality of first memory cells, and the preset standard threshold. As shown in FIG. 6b, “?” is a position where the near ranges of two memory cells overlap, a threshold level corresponding to one of the memory cells is 50%, and a threshold level corresponding to the other memory cell is 75%; and when the standard threshold is set to 200, a reset threshold of “?” is 75.

In some embodiments of the present disclosure, a processor of the server accesses memory through a cache line, data stored in a plurality of memory particles constitutes the cache line, each of the memory particles includes at least one memory symbol, the memory symbol includes data stored by a plurality of memory cells, each of the memory cells has a memory addresses in a corresponding memory particles, and the plurality of memory cells located at the same memory row have the same memory row address; and the method further includes the following operations.

A memory address corresponding to the memory cell, which stores the first piece of data, in the cache line is determined as a cache line address of the cache line.

The cache line is the smallest unit of memory accessed by the processor of the server. The cache line is read by a memory controller of the processor. In one example, one cache line may include 512-bit data, and one memory cell represents one-bit data. It is understandable that, the sizes of the memory particles are related to the model of the DIMM. When the DIMM is ×4, one memory particle includes one memory symbol; and when the DIMM is ×8, one memory particle includes 2 memory symbols. Each memory symbol includes data stored by the plurality of memory cells; the memory address is an address in which the memory cell is stored in the memory particle; and the memory cells located at the same memory row have the same memory row address.

Data in the memory of the server changes continuously, and a memory address corresponding to the memory cell, which stores the first piece of data, in the cache line may be determined as the cache line address of the cache line.

When the processor accesses the cache lines with the same cache line address at different moments, the cache lines include at least two memory cells in which the CE occurs, and when a cross-symbol error occurs in the at least two memory cells and the memory row addresses of the at least two memory cells are the same, the memory page is determined as a fault page.

When the server accesses the cache lines with the same cache line address at different moments, the cache lines include at least two memory cells in which the CE occurs, and when a cross-symbol error occurs in the at least two memory cells and the memory row addresses of the at least two memory cells are the same, the memory page is determined as the fault page.

In some embodiments of the present disclosure, the method further includes the following operation.

When the processor accesses the cache lines with the same cache line address at different moments, and when the at least two memory cells in which the CE occurs are located at different memory symbols, it is determined that the cross-symbol error occurs.

When the processor accesses the cache lines with the same cache line address at different moments, and when the at least two memory cells in which the CE occurs are respectively located at different memory symbols, it may be determined that the cross-symbol error occurs.

In some embodiments of the present disclosure, determining whether the information of the CE meets the error determination condition of the memory row address includes the following operations.

Whether the memory row addresses of the memory cells, in which the CE occurs, in at least two fault pages are the same is determined.

When the memory row addresses of the memory cells, in which the CE occurs, in at least two fault pages are the same, memory rows in which the memory cells are located are determined as fault rows.

A memory page associated with the fault rows is determined as an executable page.

When whether the error determination condition of the memory row address is met is determined, when it is determined that there are at least two fault pages, and memory row addresses of the memory cells, in which the CE occurs, in the two fault pages are the same, the memory rows at which the memory cells are located are determined as the fault rows, and all the memory pages associated with the fault rows are determined as the executable pages. As shown in FIG. 7a, “x” represents data in which an error occurs, there are two memory cells in the cache line in which the CE occurs at different moments, a cross-symbol error occurs in the two memory cells, and the memory row addresses are the same, such that the memory page in which the cache line is located is determined as the fault page. As shown in FIG. 7b, “x” represents the data in which an error occurs, the memory cells, in which the CE occurs, in two fault pages are located at the same memory row, and the memory row addresses are the same, such that the memory row is determined as the fault row, and the memory page associated with the fault row is determined as the executable page.

At step 903, when the BIOS detects the executable page, an interrupt signal is generated and sent to the OS.

When the BIOS detects the executable page, one interrupt signal is generated and sent to the OS for software interrupt.

At step 904, the OS notifies the BIOS to acquire memory page address information of the executable page.

After receiving the interrupt signal, the OS notifies the BIOS to acquire the memory page address information.

At step 905, the BIOS records the memory page address information in a platform error record.

After acquiring the memory page address information, the BIOS records the memory page address information in the platform error record.

At step 906, an isolation sign is set for the executable page based on the platform error record.

After the BIOS records the memory page address information in the platform error record, the isolation sign may be set for the executable page.

At step 907, the OS performs memory fault isolation on the executable page by identifying the isolation sign.

When the OS accesses memory data, the OS performs memory fault isolation on the executable page by identifying the isolation sign, thereby avoiding the calling of the memory cell in which a fault may exist.

In the embodiments of the present disclosure, by means of, when the CE occurs in the memory cell, statistically collecting the information of the CE, when the number of times that the CE occurs in the memory cell reaches the reset threshold, determining, as the executable page, the memory page in which the memory cell is located, or when the information of the CE meets the error determination condition of the memory row address, determining, as the executable page, the memory page associated with the memory row in which the memory cell is located, and performing memory fault isolation on the executable page, threshold resetting of a near space of the memory cell, in which the number of times that a memory fault occurs exceeds a threshold, is realized; an error determination mechanism of the memory row address and a fault determination mechanism regarding a memory page are introduced, such that the occurrence probability of a UCE may be effectively reduced, and the occurrence of the UCE is thus suppressed, thereby avoiding situations such as a server having a kernel panic and the server going down; and meanwhile, by statistically collecting the information of the executable page, causes of errors may be further analyzed.

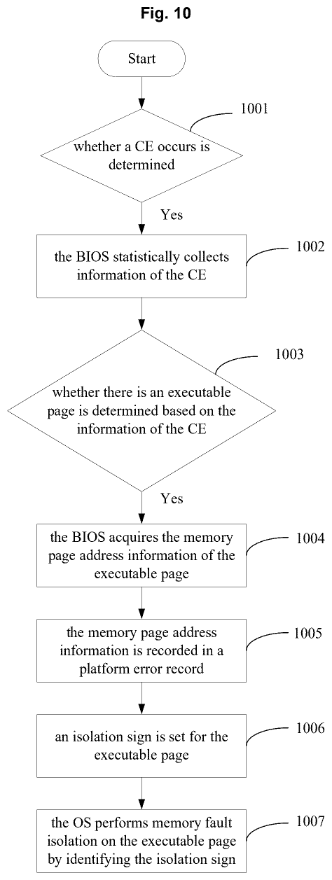

FIG. 10 is a flowchart of another memory fault early-warning method according to embodiments of the present disclosure. The method may include the following steps.

At step 1001, whether a CE occurs is determined, and when the CE occurs, step 1002 is executed.

At step 1002, the BIOS statistically collects information of the CE.

At step 1003, whether there is an executable page is determined based on the information of the CE, where a determination method may include: determining whether the number of times that the CE occurs in the memory cell reaches a preset standard threshold; determining whether the number of times that the CE occurs in the memory cell reaches a reset threshold; determining whether the information of the CE meets an error determination condition of a memory row address; and determining that the sum of the number of times that the CE occurs in the memory cells in the same memory page reaches a preset error threshold, and when any one of the conditions is met, executing step 1004.

At step 1004, the BIOS acquires the memory page address information of the executable page.

At step 1005, the memory page address information is recorded in a platform error record.

At step 1006, an isolation sign is set for the executable page.

At step 1007, the OS performs memory fault isolation on the executable page by identifying the isolation sign.

It is to be noted that, for ease of simple description, the method embodiments are all expressed as a series of action combinations, but those skilled in the art should know that the embodiments of the present disclosure are not limited by the described action sequence, as according to the embodiments of the present disclosure, some steps may be performed in other sequences or simultaneously. Then, those skilled in the art should also know that the embodiments described in the specification are all preferred embodiments, and the actions involved are not necessarily required by the embodiments of the present disclosure.

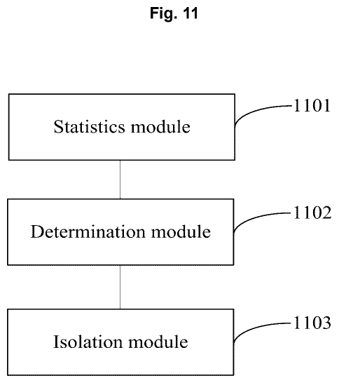

FIG. 11 is a block structural diagram of a memory fault early-warning apparatus according to embodiments of the present disclosure. The apparatus is applied to a server and may include the following modules.

The statistics module 1101 is configured to, when a CE occurs in a memory cell, statistically collect information of the CE.

The determination module 1102 is configured to, when the number of times that the CE occurs in the memory cell reaches a reset threshold, determine, as an executable page, a memory page in which the memory cell is located, or when the information of the CE meets an error determination condition of a memory row address, determine, as the executable page, a memory page associated with a memory row in which the memory cell is located.

The isolation module 1103 is configured to perform memory fault isolation on the executable page.

In some embodiments of the present disclosure, the apparatus further includes a first memory cell determination module and a first executable page determination module.

The first memory cell determination module is configured to, when the number of times that the CE occurs in the memory cell reaches a preset standard threshold, determine the memory cell as a first memory cell.

The first executable page determination module is configured to determine, as the executable page, the memory page in which the first memory cell is located.

In some embodiments of the present disclosure, the apparatus further includes a hard fault determination module.

The hard fault determination module is configured to, when the number of times that the CE occurs in the memory cell reaches the preset standard threshold, determine that a hard fault occurs in the first memory cell.

In some embodiments of the present disclosure, the memory cells are connected to each other in rows and columns, and the apparatus further includes a second memory cell determination module and a reset threshold determination module.

The second memory cell determination module is configured to determine, as second memory cells, a plurality of memory cells within a preset near range of the first memory cell.

The reset threshold determination module is configured to determine the reset threshold based on distances between the second memory cells and the first memory cell, and the preset standard threshold.

In some embodiments of the present disclosure, the reset threshold determination module further includes a reset threshold determination sub-module.

The reset threshold determination sub-module is configured to, when there are a plurality of first memory cells around the second memory cell, determine the reset threshold based on distances between the second memory cell and the plurality of first memory cells, and the preset standard threshold.

In some embodiments of the present disclosure, a processor of the server accesses memory through a cache line, data stored in a plurality of memory particles constitutes the cache line, each of the memory particles includes at least one memory symbol, the memory symbol includes data stored by a plurality of memory cells, each of the memory cells has a memory addresses in a corresponding memory particles, and the plurality of memory cells located at the same memory row have the same memory row address; and the apparatus further includes a cache line address module and a fault page module.

The cache line address module is configured to determine, as a cache line address of the cache line, a memory address corresponding to a memory cell in the cache line that stores a first piece of data.

The fault page module is configured to, when the processor accesses the cache lines with the same cache line address at different moments, the cache lines including at least two memory cells in which the CE occurs, and when a cross-symbol error occurs in the at least two memory cells and the memory row addresses of the at least two memory cells are the same, determine the memory page as a fault page.

In some embodiments of the present disclosure, the determination module 1102 includes a memory row address determination sub-module, a fault row determination sub-module, and an executable page determination sub-module.

The memory row address determination sub-module is configured to determine whether the memory row addresses of the memory cells, in which the CE occurs, in at least two fault pages are the same.

The fault row determination sub-module is configured to determine, as a fault row, the memory row in which the memory cell is located when the memory row addresses of the memory cells, in which the CE occurs, in at least two fault pages are the same.

The executable page determination sub-module is configured to determine, as an executable page, a memory page associated with the fault row.

In some embodiments of the present disclosure, the apparatus further includes a cross-symbol error module.

The cross-symbol error module is configured to, when the processor accesses the cache lines with the same cache line address at different moments, and when the at least two memory cells in which the CE occurs are located at different memory symbols, determine that the cross-symbol error occurs.

In some embodiments of the present disclosure, the server includes a BMC, a BIOS, and an OS; a register is disposed in the server; and when the information of the CE is statistically collected by the BMC, the apparatus further includes a collection module.

The collection module is configured to collect registers in which the CE occurs in a polling manner based on the BMC.

In some embodiments of the present disclosure, the apparatus further includes a first storage module.

The first storage module is configured to store, by using the register, memory page address information where the memory cell, in which the CE occurs, is located, system address information, and row information.

In some embodiments of the present disclosure, the isolation module 1103 includes a first detection sub-module, a first acquisition sub-module, a first recording sub-module, a first setting sub-module, and a first isolation sub-module.

The first detection sub-module is configured to, when the BMC detects the executable page, generate and send an interrupt signal to the OS.

The first acquisition sub-module is configured to notify, by using the OS, the BIOS to acquire memory page address information of the executable page.

The first recording sub-module is configured to record the memory page address information in a platform error record by using the BIOS.

The first setting sub-module is configured to set an isolation sign for the executable page based on the platform error record.

The first isolation sub-module is configured to perform memory fault isolation on the executable page by identifying the isolation sign using the OS.

In some embodiments of the present disclosure, the server includes the BIOS and the OS; and when the information of the CE is statistically collected by the BIOS, the apparatus further includes a triggering module.

The triggering module is configured to trigger a system management interrupt when detecting the occurrence of a CE.

In some embodiments of the present disclosure, the apparatus further includes a second storage module.

The second storage module is configured to statistically collect, by using the BIOS, memory page address information where the memory cell, in which the CE occurs, is located, system address information, and row information.

In some embodiments of the present disclosure, the isolation module 1103 further includes a second detection sub-module, a second acquisition sub-module, a second recording sub-module, a second setting sub-module, and a second isolation sub-module.

The second detection sub-module is configured to, when the BIOS detects the executable page, generate and send an interrupt signal to the OS.

The second acquisition sub-module is configured to notify, by using the OS, the BIOS to acquire memory page address information of the executable page.

The second recording sub-module is configured to record the memory page address information in a platform error record by using the BIOS.

The second setting sub-module is configured to set an isolation sign for the executable page based on the platform error record.

The second isolation sub-module is configured to perform memory fault isolation on the executable page by identifying the isolation sign using the OS.

In some embodiments of the present disclosure, the apparatus further includes a second executable page determination module.

The second executable page determination module is configured to, when a sum of the number of times that the CE occurs in the memory cells located in the same memory page reaches a preset error threshold, determine the same memory page as the executable page, where the preset error threshold is a threshold set for the memory page.

In some embodiments of the present disclosure, the apparatus further includes a CE detection module.

The CE detection module is configured to detect, by the server, whether the CE occurs.

For the apparatus embodiments, since the apparatus embodiments are basically similar to the method embodiments, the description is relatively simple, and for related parts, refer to the partial descriptions of the method embodiments.

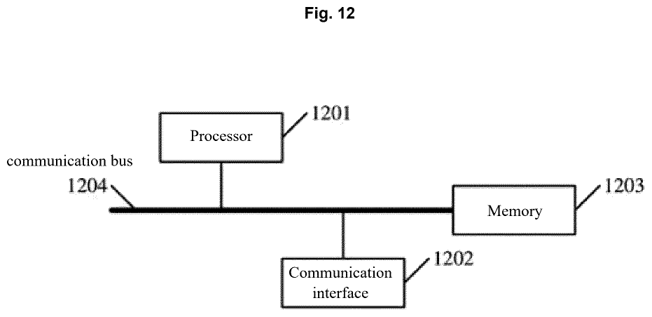

Furthermore, an embodiment of the present disclosure further provides an electronic device. As shown in FIG. 12, the electronic device includes a processor 1201, a communication interface 1202, a memory 1203, and a communication bus 1204. The processor 1201, the communication interface 1202, and the memory 1203 communicate with each other by using the communication bus 1204.

The memory 1203 is configured to store a computer program.

The processor 1201 is configured to implement the following steps when executing the program stored on the memory 1203.

When a CE occurs in a memory cell, information of the CE is statistically collected.

When the number of times that the CE occurs in the memory cell reaches a reset threshold, a memory page in which the memory cell is located is determined as an executable page, or when the information of the CE meets an error determination condition of a memory row address, a memory page associated with a memory row in which the memory cell is located is determined as the executable page.

Memory fault isolation is performed on the executable page.

In some embodiments of the present disclosure, a method of determining the executable page further includes the following operations.

When the number of times that the CE occurs in the memory cell reaches a preset standard threshold, the memory cell is determined as a first memory cell.

A memory page in which the first memory cell is located is determined as the executable page.

In some embodiments of the present disclosure, the method further includes the following operation.

When the number of times that the CE occurs in the memory cell reaches the preset standard threshold, it is determined that a hard fault occurs in the first memory cell.

In some embodiments of the present disclosure, the memory cells are connected to each other in rows and columns, and a method of determining the reset threshold includes the following operations.

A plurality of memory cells within a preset near range of the first memory cell are determined as second memory cells.

The reset threshold is determined based on distances between the second memory cells and the first memory cell, and the preset standard threshold.

In some embodiments of the present disclosure, the method further includes the following operation.

When there are a plurality of first memory cells around a second memory cell, the reset threshold is determined based on distances between the second memory cell and the plurality of first memory cells, and the preset standard threshold.

In some embodiments of the present disclosure, a processor of the server accesses memory through a cache line, data stored in a plurality of memory particles constitutes the cache line, each of the memory particles includes at least one memory symbol, the memory symbol includes data stored by a plurality of memory cells, each of the memory cells has a memory addresses in a corresponding memory particles, and the plurality of memory cells located at the same memory row have the same memory row address; and the method further includes the following operations.

A memory address corresponding to a memory cell, which stores a first piece of data, in the cache line is determined as a cache line address of the cache line.

When the processor accesses the cache lines with the same cache line address at different moments, the cache lines include at least two memory cells in which the CE occurs, and when a cross-symbol error occurs in the at least two memory cells and the memory row addresses of the at least two memory cells are the same, the memory page is determined as a fault page.

In some embodiments of the present disclosure, determining whether the information of the CE meets the error determination condition of the memory row address includes the following operations.

Whether the memory row addresses of the memory cells, in which the CE occurs, in at least two fault pages are the same is determined.

When the memory row addresses of the memory cells, in which the CE occurs, in at least two fault pages are the same, memory rows in which the memory cells are located are determined as fault rows.

A memory page associated with the fault rows is determined as an executable page.

In some embodiments of the present disclosure, the method further includes the following operation.

When the processor accesses the cache lines with the same cache line address at different moments, and when the at least two memory cells in which the CE occurs are located at different memory symbols, it is determined that the cross-symbol error occurs.

In some embodiments of the present disclosure, the server includes a BMC, a BIOS, and an OS; a register is disposed in the server; and when the information of the CE is statistically collected by the BMC, the method further includes the following operation.

The BMC collects, in a polling manner, registers in which the CE occurs.

In some embodiments of the present disclosure, the method further includes the following operation.

The register stores memory page address information where the memory cell, in which the CE occurs, is located, system address information, and row information.

In some embodiments of the present disclosure, performing memory fault isolation on the executable page includes the following operations.

When the BMC detects the executable page, an interrupt signal is generated and sent to the OS.

The OS notifies the BIOS to acquire memory page address information of the executable page.

The BIOS records the memory page address information in a platform error record.

An isolation sign is set for the executable page based on the platform error record.

The OS performs memory fault isolation on the executable page by identifying the isolation sign.

In some embodiments of the present disclosure, the server includes a BIOS and an OS; and when the information of the CE is statistically collected by the BIOS, the method further includes the following operation.

A system management interrupt is triggered when the occurrence of a CE is detected.

In some embodiments of the present disclosure, the method further includes the following operation.

The BIOS statistically collects memory page address information where the memory cell, in which the CE occurs, is located, system address information, and row information.

In some embodiments of the present disclosure, performing memory fault isolation on the executable page includes the following operations.

When the BIOS detects the executable page, an interrupt signal is generated and sent to the OS.

The OS notifies the BIOS to acquire memory page address information of the executable page.

The BIOS records the memory page address information in a platform error record.

An isolation sign is set for the executable page based on the platform error record.

The OS performs memory fault isolation on the executable page by identifying the isolation sign.

In some embodiments of the present disclosure, a method of determining the executable page further includes the following operation.

When a sum of the number of times that the CE occurs in the memory cells located in the same memory page reaches a preset error threshold, the same memory page is determined as the executable page; and the preset error threshold is a threshold set for the memory page.

In some embodiments of the present disclosure, a memory fault includes a CE and a UCE.

In some embodiments of the present disclosure, the method further includes the following operation.

The server detects whether the CE occurs.

The communication bus mentioned in the above terminal may be a Peripheral Component Interconnect (PCI) bus or an Extended Industry Standard Architecture (EISA) bus, or the like. The communication bus may be divided into an address bus, a data bus, a control bus, and the like. For ease of presentation, only one thick line is used in FIG. 12, but it does not mean that there is only one bus or one type of buses.

The communication interface is configured to achieve a communication between the terminal and other devices.

The memory may include a Random Access Memory (RAM), or may include a non-transitory memory, such as at least one disk memory. In some embodiments of the present disclosure, the memory may also be at least one storage apparatus located remotely from the foregoing processor.

The above processor may be a general processor, including a Central Processing Unit (CPU) and a Network Processor (NP), or may be a Digital Signal Processor (DSP), an Application Specific Integrated Circuit (ASIC), a Field-Programmable Gate Array (FPGA) or other programmable logic devices, discrete gate or transistor logic devices, and discrete hardware components.

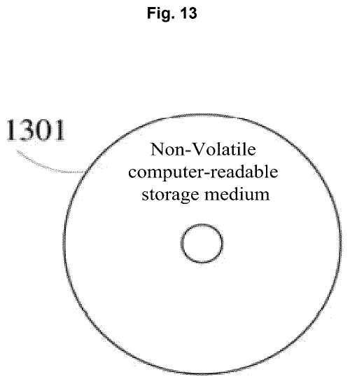

As shown in FIG. 13, another embodiment of the present disclosure further provides a non-transitory computer-readable storage medium 1301. The non-transitory computer-readable storage medium stores an instruction. When the instruction is run on a computer, the computer is enabled to execute the memory fault early-warning method in the above embodiments.

Another embodiment of the present disclosure further provides a computer program product including an instruction. When the computer program product is operated on a computer, the computer executes the memory fault early-warning method in the above embodiments.

In the above embodiments, it may be implemented in whole or in part by software, hardware, firmware, or any combination thereof. When the software is used for implementation, it may be implemented in whole or in part in the form of the computer program product. The computer program product includes at least one computer instruction. When the above computer program instruction is loaded and executed on a computer, the above processes or functions according to the embodiments of the present disclosure are generated in whole or in part. The above computer may be a general computer, a special computer, a computer network, or other programmable apparatus. The computer instruction may be stored in the non-transitory computer-readable storage medium or transmitted from one non-transitory computer-readable storage medium to another non-transitory computer-readable storage medium. For example, the above computer instruction may be transmitted from a website site, a computer, a server, or a data center to another website site, another computer, another server, or another data center via wire (for example, a coaxial cable, an optical fiber, a Digital Subscriber Line (DSL)) or wireless (for example, infrared, wireless, microwave, or the like). The non-transitory computer-readable storage medium may be any available medium that can be accessed by a computer, or a data storage device, such as a server and a data center, that includes at least one available medium integrated. The above available medium may be a magnetic medium (for example, a floppy disk, a hard disk, and a magnetic tape), an optical medium (for example, DVD), or a semiconductor medium (for example, Solid State Disk (SSD)), and the like.

It is also to be noted that relational terms such as first and second are used merely to distinguish one entity or operation from another entity or operation herein, and do not necessarily require or imply the existence of any such actual relationship or order between these entities or operations. Furthermore, terms “comprise”, “include” or any other variants are intended to encompass non-exclusive inclusion, such that a process, a method, an article or a device including a series of elements not only include those elements, but also includes other elements not listed explicitly or includes intrinsic elements for the process, the method, the article, or the device. Without any further limitation, an element defined by the phrase “comprising one” does not exclude existence of other same elements in the process, the method, the article, or the device that includes the elements.

Each embodiment in this specification is described in a related manner, and reference may be made to each other for the same and similar parts among the various embodiments, and each embodiment focuses on the differences from other embodiments. In particular, for the system embodiments, since the system embodiments are basically similar to the method embodiments, the description is relatively simple, and for related parts, refer to the partial descriptions of the method embodiments.

The above are merely some embodiments of the present disclosure, and are not intended to limit the protection scope of the present disclosure. Any modifications, equivalent replacements, improvements and the like made within the spirit and principle of the present disclosure shall fall within the scope of protection of the present disclosure.

1. A memory fault early-warning method, applied to a server and comprising:
when a Correctable Error (CE) occurs in a memory cell, statistically collecting information of the CE;
when the number of times that the CE occurs in the memory cell reaches a reset threshold, determining, as an executable page, a memory page in which the memory cell is located, or when the information of the CE meets an error determination condition of a memory row address, determining, as the executable page, a memory page associated with a memory row in which the memory cell is located; and performing memory fault isolation on the executable page,
wherein a processor of the server accesses memory through a cache line, data stored in a plurality of memory particles constitutes the cache line, each of the memory particles comprises at least one memory symbol, the memory symbol comprises data stored by a plurality of memory cells, each of the memory cells has a memory addresses in a corresponding memory particles, and the plurality of memory cells located at the same memory row have the same memory row address; and the method further comprises:
determining, as a cache line address of the cache line, a memory address corresponding to a memory cell, which stores a first piece of data, in the cache line; and
when the processor accesses the cache lines with the same cache line address at different moments, the cache lines comprising at least two memory cells in which the CE occurs, and when a cross-symbol error occurs in the at least two memory cells and the memory row addresses of the at least two memory cells are the same, determining the memory page as a fault page.

2. The method as claimed in claim 1, wherein a method of determining the executable page further comprises:
when the number of times that the CE occurs in the memory cell reaches a preset standard threshold, determining the memory cell as a first memory cell; and
determining, as the executable page, a memory page in which the first memory cell is located.

3. The method as claimed in claim 2, further comprising:
when the number of times that the CE occurs in the memory cell reaches the preset standard threshold, determining that a hard fault occurs in the first memory cell.

4. The method as claimed in claim 3, wherein the memory cells are connected to each other in rows and columns, and a method of determining the reset threshold comprises:
determining, as second memory cells, a plurality of memory cells within a preset near range of the first memory cell; and
determining the reset threshold based on distances between the second memory cells and the first memory cell, and the preset standard threshold.

5. The method as claimed in claim 4, further comprising:
when there are a plurality of first memory cells around a second memory cell, determining the reset threshold based on distances between the second memory cell and the plurality of first memory cells, and the preset standard threshold.

6. (canceled)

7. The method as claimed in claim 1, wherein determining whether the information of the CE meets the error determination condition of the memory row address comprises:
determining whether the memory row addresses of the memory cells, in which the CE occurs, in at least two fault pages are the same;
when the memory row addresses of the memory cells, in which the CE occurs, in at least two fault pages are the same, determining, as fault rows, memory rows in which the memory cells are located; and
determining, as an executable page, a memory page associated with the fault rows.

8. The method as claimed in claim 7, further comprising:
when the processor accesses the cache lines with the same cache line address at different moments, and when the at least two memory cells in which the CE occurs are located at different memory symbols, determining that the cross-symbol error occurs.

9. The method as claimed in claim 1, wherein the server comprises a Baseboard Management Controller (BMC), a Basic Input Output System (BIOS), and an Operating System (OS); a register is disposed in the server; and when the information of the CE is statistically collected by the BMC, the method further comprises:
the BMC collecting, in a polling manner, registers in which the CE occurs.

10. The method as claimed in claim 9, further comprising:
storing, by the register, memory page address information where the memory cell, in which the CE occurs, is located, system address information, and row information.

11. The method as claimed in claim 10, wherein performing memory fault isolation on the executable page comprises:
when the BMC detects the executable page, generating and sending an interrupt signal to the OS;
notifying, by the OS, the BIOS to acquire memory page address information of the executable page;
recording, by the BIOS, the memory page address information in a platform error record;
setting an isolation sign for the executable page based on the platform error record; and
performing, by the OS, memory fault isolation on the executable page by identifying the isolation sign.

12. The method as claimed in claim 1, wherein the server comprises a BIOS and an OS; and when the information of the CE is statistically collected by the BIOS, the method further comprises:
triggering a system management interrupt when detecting the occurrence of a CE.

13. The method as claimed in claim 12, further comprising:
statistically collecting, by the BIOS, memory page address information where the memory cell, in which the CE occurs, is located, system address information, and row information.

14. The method as claimed in claim 13, wherein performing memory fault isolation on the executable page comprises:
when detecting the executable page, generating and sending, by the BIOS, an interrupt signal to the OS;
notifying, by the OS, the BIOS to acquire memory page address information of the executable page;
recording, by the BIOS, the memory page address information in a platform error record;
setting an isolation sign for the executable page based on the platform error record; and
performing, by the OS, memory fault isolation on the executable page by identifying the isolation sign.

15. The method as claimed in claim 1, wherein a method of determining the executable page further comprises:
when a sum of the number of times that the CE occurs in the memory cells located in the same memory page reaches a preset error threshold, determining the same memory page as the executable page, wherein the preset error threshold is a threshold set for the memory page.

16. The method as claimed in claim 1, wherein a memory fault comprises a CE and an Uncorrectable Error (UCE).

17. The method as claimed in claim 16, further comprising:
detecting, by the server, whether the CE occurs.

18. (canceled)

19. An electronic device, comprising:
a processor, a communication interface, a memory, and a communication bus, wherein the processor, the communication interface, and the memory communicate with each other through the communication bus;
the memory is configured to store a computer program; and
the processor is configured to execute the computer program stored in the memory, and when the computer program is executed by the processor, cause the processor to:
when a Correctable Error (CE) occurs in a memory cell, statistically collect information of the CE;
when the number of times that the CE occurs in the memory cell reaches a reset threshold, determine, as an executable page, a memory page in which the memory cell is located, or when the information of the CE meets an error determination condition of a memory row address, determine, as the executable page, a memory page associated with a memory row in which the memory cell is located; and
perform memory fault isolation on the executable page,
wherein a processor of the server accesses memory through a cache line, data stored in a plurality of memory particles constitutes the cache line, each of the memory particles comprises at least one memory symbol, the memory symbol comprises data stored by a plurality of memory cells, each of the memory cells has a memory addresses in a corresponding memory particles, and the plurality of memory cells located at the same memory row have the same memory row address; and
determine, as a cache line address of the cache line, a memory address corresponding to a memory cell, which stores a first piece of data, in the cache line; and
when the processor accesses the cache lines with the same cache line address at different moments, the cache lines comprising at least two memory cells in which the CE occurs, and when a cross-symbol error occurs in the at least two memory cells and the memory row addresses of the at least two memory cells are the same, determine the memory page as a fault page.

20. At least one non-transitory computer-readable storage medium, wherein the non-transitory computer-readable storage medium is configured to store an instruction, when the instruction is executed by at least one processor, cause the processor to:
when a Correctable Error (CE) occurs in a memory cell, statistically collect information of the CE;
when the number of times that the CE occurs in the memory cell reaches a reset threshold, determine, as an executable page, a memory page in which the memory cell is located, or when the information of the CE meets an error determination condition of a memory row address, determine, as the executable page, a memory page associated with a memory row in which the memory cell is located; and
perform memory fault isolation on the executable page,
wherein a processor of the server accesses memory through a cache line, data stored in a plurality of memory particles constitutes the cache line, each of the memory particles comprises at least one memory symbol, the memory symbol comprises data stored by a plurality of memory cells, each of the memory cells has a memory addresses in a corresponding memory particles, and the plurality of memory cells located at the same memory row have the same memory row address; and
determine, as a cache line address of the cache line, a memory address corresponding to a memory cell, which stores a first piece of data, in the cache line; and
when the processor accesses the cache lines with the same cache line address at different moments, the cache lines comprising at least two memory cells in which the CE occurs, and when a cross-symbol error occurs in the at least two memory cells and the memory row addresses of the at least two memory cells are the same, determine the memory page as a fault page.

21. The electronic device as claimed in claim 19, wherein when the computer program is executed by the processor, cause the processor to:
when the number of times that the CE occurs in the memory cell reaches a preset standard threshold, determine the memory cell as a first memory cell; and
determine, as the executable page, a memory page in which the first memory cell is located.

22. The electronic device as claimed in claim 21, wherein when the computer program is executed by the processor, cause the processor to:
when the number of times that the CE occurs in the memory cell reaches the preset standard threshold, determine that a hard fault occurs in the first memory cell.
